(19) United States
(12) Patent Application Publication
(10) Pub. No.: US 2015/0149458 A1
(43) Pub. Date: May 28, 2015

(54) METHOD FOR GENERATING BLOCKS FOR VIDEO SEARCHING AND METHOD FOR PROCESSING QUERIES BASED ON BLOCKS GENERATED THEREBY

(71) Applicant: POSTECH ACADEMY-INDUSTRY FOUNDATION, Pohang-si, Gyeongsangbuk-do (KR)

(72) Inventors: Hwan Jo Yu, Pohang-si (KR); Young Woo Kim, Seoul (KR)

(21) Appl. No.: 14/412,799

(22) PCT Filed: Mar. 11, 2013
(86) PCT No.: PCT/KR2013/001946

§ 371 Date: Jan. 5, 2015

(30) Foreign Application Priority Data
Jul. 11, 2012 (KR) 10-2012-0075666

(51) Int. Cl. G06F 17/30; H04N 5/14

(52) U.S. Cl. CPC G06F 17/30825; H04N 5/144
USPC 707/736; 348/699

(57) ABSTRACT

The present invention relates to a method for generating blocks for video searching and to a method for processing queries based on the blocks generated thereby. One embodiment of the present invention includes the steps of: detecting a reference frame of which the position information and/or direction information, which are forms of space information on a frame, nonlinearly changes from among frames forming a video; and generating a tilt block including a plurality of frames on the basis of the reference frame. Accordingly, compared to the prior art, the same amount of queries can be processed using a smaller amount of memory and in a shorter amount of time.

This application claims priority to Korean Patent Application No. 2012-0075666 filed on Jul. 11, 2012 in the Korean Intellectual Property Office (KIPO), the entire contents of which are hereby incorporated by reference.

### BACKGROUND

1. Technical Field

Example embodiments of the present invention relate in general to a technique of generating a block for video retrieval and processing a query and more specifically to a method of generating a block based on space information of a video and a method of processing a query based on the generated block.

2. Related Art

Along with the rapid population of video recording devices (for example, a digital camera, a smartphone, and the like), amateurs in addition to experts can easily produce a video. In addition, multimedia content such as a video can be easily uploaded or downloaded over the Internet, which results from the development of communication technology.

To download a desired video, a user retrieves the desired video using a search engine. The search engine retrieves the video based on text information such as a title of the video, subtitles included in the video, and the like. Since such a search engine retrieves a video based on only text information of the video, the user cannot accurately retrieve the desired video.

Particularly, when a user desires to retrieve a video containing information on a specific region and retrieves the video based on only text information without using space information (for example, a place where the video is photographed) of the video, the user cannot accurately retrieve the desired video.

### SUMMARY

Accordingly, example embodiments of the present invention are provided to substantially obviate one or more problems due to limitations and disadvantages of the related art.

Example embodiments of the present invention provide a method of generating a block for video retrieval based on space information of frames constituting a video.

Example embodiments of the present invention also provide an apparatus for generating a block for video retrieval based on space information of frames constituting a video.

Example embodiments of the present invention also provide a method of processing a query on the basis of a block that is generated based on space information of frames.

Example embodiments of the present invention also provide an apparatus for processing a query on the basis of a block that is generated based on space information of frames.

In some example embodiments, a method of generating a block for video retrieval, which is performed by an apparatus for generating the block for the video retrieval, the method includes detecting a reference frame having at least one of position information and direction information that changes nonlinearly from among frames constituting a video, the position information and direction information being space information of the frame, and generating a tilt block including a plurality of frames based on the reference frame.

The detecting of the reference frame may include generating a regression line based on a start frame and an end frame among the frames constituting the video, selecting any point having the same time information as any frame constituting the video on the regression line, calculating a distance between the any point on the regression line and the any frame, and determining the any frame as the reference frame when the calculated distance is greater than a predefined reference distance.

The detecting of the reference frame may include calculating a median value of direction information based on direction information of the frames constituting the video and determining any frame as the reference frame among the frames constituting the video when a difference between the median value and direction information of the any frame is greater than a predefined reference value.

The generating of the tilt block may include classifying the frames constituting the video into at least two groups based on the reference frame and generating a tilt block including frames constituting a group in parallel with a line formed by a start frame and an end frame among the frames constituting the group.

In other example embodiments, an apparatus for generating a block for video retrieval, the apparatus includes a detection unit configured to detect a reference frame having at least one of position information and direction information that changes nonlinearly from among frames constituting a video, the position information and direction information being space information of the frame, and a generation unit configured to generate a tilt block including a plurality of frames based on the reference frame, in which the generation unit generates the tilt block in parallel with a line formed by a start frame and an end frame among the plurality of frames.

In still other example embodiments, a method of processing a query by a query processing apparatus, the method includes extracting a tilt block corresponding to the query from among tilt blocks including a plurality of frames constituting a video, extracting two unit blocks corresponding to the query based on a distance between the query and a start frame constituting the extracted tilt block from among the unit blocks including the frames constituting the extracted tilt block, and extracting a unit block including the frame corresponding to the query based on position information of a frame included in any unit block from among between the extracted two unit blocks and a unit block positioned between the two unit blocks, in which the tilt block is generated in parallel with a line formed by a start frame and an end frame constituting the tilt block.

The extracting of the tilt block corresponding to the query may include, when the query is a range query, detecting critical points at which the range query and the tilt blocks overlap each other and detecting a tilt block including the critical points from among the tilt blocks.

The extracting of the two unit blocks may include extracting a first unit block corresponding to a critical point closest to the start frame and a second unit block corresponding to a critical point farthest from the start frame, from among the frames constituting the extracted tilt block.

The extracting of the unit block including the frame corresponding to the query may include extracting a unit block including a frame corresponding to the range query based on position information of a frame included in any unit block among the first unit block, the second unit block, and a unit block positioned between the first unit block and the second unit block.

In yet still other example embodiments, a query processing apparatus includes a first extraction unit configured to extract a tilt block corresponding to a query from among tilt blocks including a plurality of frames constituting a video, a second extraction unit configured to extract two unit blocks corresponding to the query based on a distance between the query and a start frame constituting the extracted tilt block from among unit blocks including the frames constituting the extracted tilt block, and a third extraction unit configured to extract a unit block including a frame corresponding to the query based on position information of a frame including any unit block from among between the extracted two unit blocks and a unit block positioned between the two unit blocks, in which the tilt block is generated in parallel with a line formed by a start frame and an end frame constituting the tilt block.

### BRIEF DESCRIPTION OF DRAWINGS

Example embodiments of the present invention will become more apparent by describing in detail example embodiments of the present invention with reference to the accompanying drawings, in which:

FIG. 1 is a conceptual view showing space information of a video frame;

FIG. 2 is a conceptual view showing a block including a plurality of frames;

FIG. 3 is a flowchart showing a method of generating a block for video retrieval according to an embodiment of the present invention;

FIG. 4 is a flowchart showing a method of generating a block for video retrieval according to an embodiment of the present invention;

FIG. 5 is a conceptual view showing a process of detecting a reference frame;

FIG. 6 is a conceptual view showing a process of generating a tilt block;

FIG. 7 is a block diagram showing a block generation apparatus for video retrieval according to an embodiment of the present invention;

FIG. 8 is a flowchart showing a method of processing a query according to an embodiment of the present invention;

FIG. 9 is a conceptual view showing a process of extracting a frame corresponding to a query;

FIG. 10 is a block diagram showing a query processing apparatus according to an embodiment of the present invention;

FIG. 11 is a graph showing performance of the query processing method according to a size of data; and

FIG. 12 is a graph showing performance of the query processing method according to change in a parameter.

### DESCRIPTION OF EXAMPLE EMBODIMENTS

Since the present invention may be variously modified and have several exemplary embodiments, specific exemplary embodiments will be shown in the accompanying drawings and be described in detail in a detailed description.

However, it should be understood that the particular embodiments are not intended to limit the present disclosure to specific forms, but rather the present disclosure is meant to cover all modification, similarities, and alternatives which are included in the spirit and scope of the present disclosure.

It will be understood that, although the terms first, second, etc. may be used herein to describe various elements, these elements should not be limited by these terms. These terms are only used to distinguish one element from another. For example, a first component may be designated as a second component, and similarly, the second component may be designated as the first component. The use of the term of ‘and/or’ means that combination of a plurality of related and described items or one item among a plurality of related and described items is included.

When it is mentioned that a certain component is “coupled with” or “connected with” another component, it may be understood that another component can exist between the two components although the component can be directly coupled or connected with the other component. Meanwhile, when it is mentioned that a certain component is “directly coupled with” or “directly connected with” another component, it has to be understood that another component does not exist between the two components.

In the following description, the technical terms are used only for explaining a specific exemplary embodiment while not limiting the present disclosure. Singular forms used herein are intended to include plural forms unless explicitly indicated otherwise. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or a combination thereof.

Unless otherwise defined, all terms (including technical and scientific terms) used herein have the same meaning as commonly understood by one of ordinary skill in the art to to which this invention belongs. Terms such as terms that are generally used and have been in dictionaries should be construed as having meanings matched with contextual meanings in the art. In this description, unless defined clearly, terms are not ideally, excessively construed as formal meanings.

Hereinafter, exemplary embodiments of the present invention will be described in detail with reference to the accompanying drawings. In describing the invention, in order to facilitate the entire understanding of the invention, like numbers refer to like elements throughout the description of the figures and the repetitive description thereof will be omitted.

Throughout the specification, a video includes a plurality of frames, a start frame denotes a frame that is positioned at a start point among frames constituting the video (hereinafter referred to as video frames), an end frame denotes a frame that is positioned at an end point among the video frames, and a frame is represented as a sector having space information in two dimensions. A unit block denotes a square block including one frame, and a tilt block denotes a square block including a plurality of frames and may be represented as a tilted square block. In addition, the unit block may denote an expected-minimum bounding rectangle (MBR), and the tilt block may denote a minimum bounding tilted rectangle (MBTR).

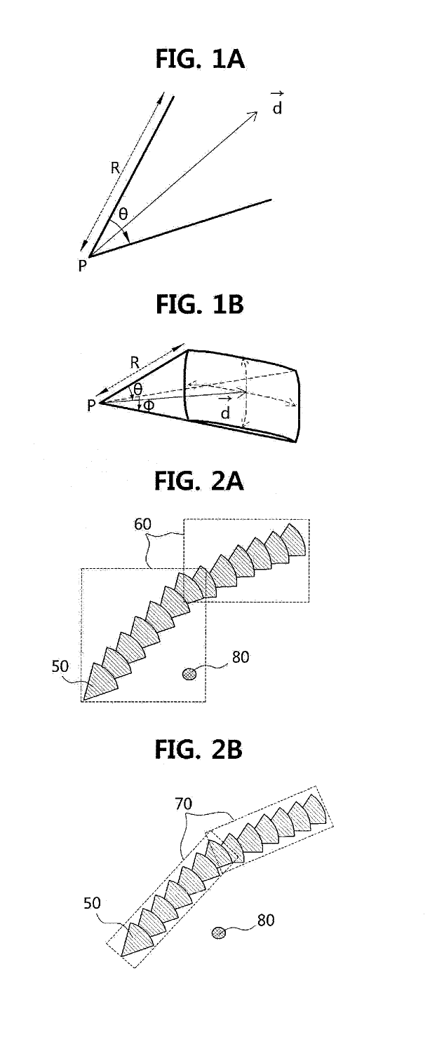

FIG. 1 is a conceptual view showing space information of a video frame. Referring to FIG. 1A, space information of a video frame in two dimensions may include position information P of a camera that photographs a frame, direction information \vec{d} of the camera, viewing angle information θ of the camera, and viewing distance information R of the camera.

Referring to FIG. 1B, space information of a video frame in three dimensions may include position information P of a camera that photographs a frame, direction information \vec{d} of the camera, horizontal viewing angle information θ of the camera, vertical viewing angle information Φ of the camera, and viewing distance information R of the camera.

Here, the position information P of the camera may be acquired through a global positioning system (GPS) sensor included in the camera and may be represented as latitude and longitude. The direction information \vec{d} of the camera may be acquired through a compass included in the camera. The viewing angle information θ of the camera in FIG. 1A and the horizontal viewing angle information θ, the vertical viewing angle information Φ, and the viewing distance information R of the camera in FIG. 1B may be acquired through characteristics and zoom levels of a camera lens. If a fixed lens is used, the viewing angle information θ of the camera in FIG. 1A and the horizontal viewing angle information θ, the vertical viewing angle information Φ, and the viewing distance information R of the camera in FIG. 1B have fixed values.

FIG. 2 is a conceptual view showing a block including a plurality of frames.

FIG. 2A is a conceptual view showing a block 60 that is generated according to a conventional minimum bounding rectangle (MBR) scheme, and FIG. 2B is a conceptual view showing a tilt block 70 that is generated according to an embodiment of the present invention. Here, each frame 50 may be considered to be positioned on a coordinate axis that represents latitudes and longitudes and may be positioned on the coordinate axis according to a generation time.

Here, the frame 50 may be represented as a sector. The vertex of the sector denotes a position of a camera that photographs the frame 50. The angle between the two sides of the vertex denotes a viewing angle of the camera. The direction of the line extending from the vertex to the center of the arc of the sector denotes a direction of the camera. The length of each side of the sector denotes a viewing distance of the camera.

In FIGS. 2A and 2B, it can be seen that the block 60 of FIG. 2A and the tilt block 70 of FIG. 2B include the same frames 50 but the size of the block 60 of FIG. 2A is much greater than that of the tilt block 70 of FIG. 2B. Here, the circle denotes a query 80. Since the query 80 of FIG. 2A is included in the block 60, the block 60 corresponding to the query 80 is detected. However, since the query 80 is not included in the frame 50 included in the block 60, the detected block 60 is wrongly detected. On the other hand, since the query 80 of FIG. 2B is not included in the tilt block 70, the tilt block 70 corresponding to the query 80 is not detected.

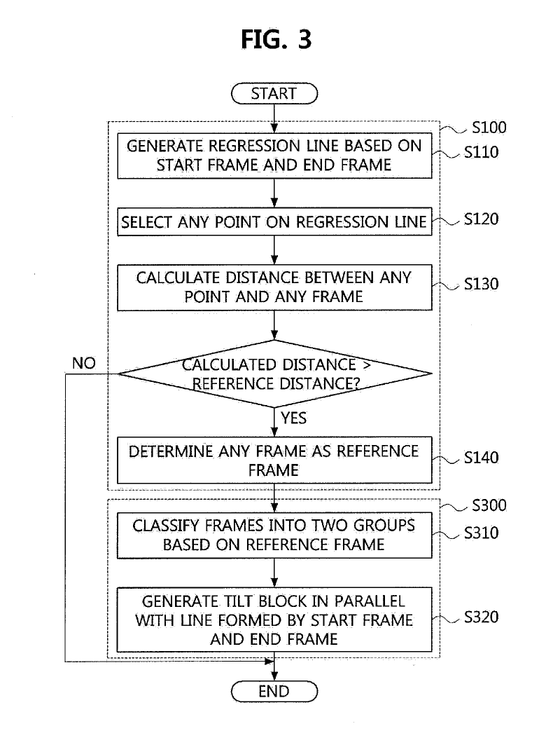

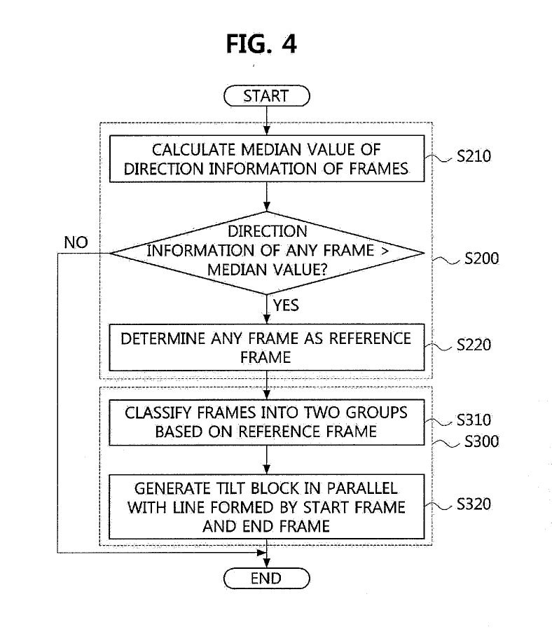

FIG. 3 is a flowchart showing a method of generating a block for video retrieval according to an embodiment of the present invention, and FIG. 4 is a flowchart showing a method of generating a block for video retrieval according to an embodiment of the present invention.

Referring to FIGS. 3 and 4, a block generation apparatus may detect a reference frame in which at least one of position information and direction information, which are space information of the frame, changes nonlinearly among the video frames (S100 and S200). Here, operation S100 is a process that detects the reference frame based on the position information of the frame and may include operations S110, S120, S130, and S140. Operation S200 is a process that detects the reference frame based on the direction information of the frame and may include operations S210 and S220.

Process of Detecting Reference Frame based on Position Information of Frame

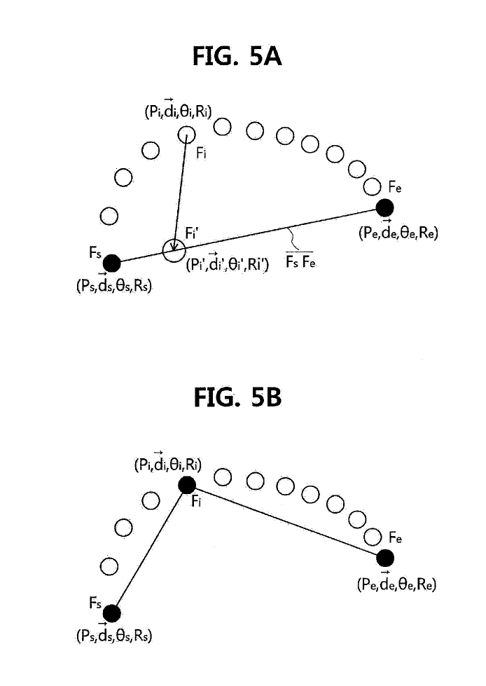

FIG. 5 is a conceptual view showing a process of detecting a reference frame.

Referring to FIG. 5, a circle denotes a frame, Fₛ denotes a start frame, Fₑ denotes an end frame, Fᵢ denotes any frame among video frames, and Fᵢ′ denotes any point that is positioned on a regression line that is formed by the start frame and the end frame. In this case, Fᵢ′ has the same time information as Fᵢ.

(Pₛ, \vec{d}ₛ, θₛ, Rₛ) denotes position information, direction information, viewing angle information, and viewing distance information of the start frame Fₛ. (Pₑ, \vec{d}ₑ, θₑ, Rₑ) denotes position information, direction information, viewing angle information, and viewing distance information of the end frame Fₑ. (Pᵢ, \vec{d}ᵢ, θᵢ, Rᵢ) denotes position information, direction information, viewing angle information, and viewing distance information of any frame Fᵢ. (Pᵢ′, \vec{d}ᵢ′, θᵢ′, Rᵢ′) denotes position information, direction information, viewing angle information, and viewing distance information of any point Fᵢ′.

The block generation apparatus may generate a regression line F̅ₛ̅F̅ₑ̅ based on the start frame Fₛ and the end frame Fₑ among the video frames (S110). That is, the block generation apparatus may connect the start frame Fₛ and the end frame Fₑ to generate the regression line F̅ₛ̅F̅ₑ̅.

After generating the regression line F̅ₛ̅F̅ₑ̅, the block generation apparatus may select any point Fᵢ′ on the regression line, which has the same time information as any frame Fᵢ constituting the video (S120). The block generation apparatus may calculate position information Pᵢ′ of any point Fᵢ′ using Equation 1 below and select any point Fᵢ′ corresponding to the calculated position information Pᵢ′:

$$Δ e = {t}_{e} - {t}_{s} \\ Δ i = {t}_{i} - {t}_{s} \\ {P}_{i}^{′} = {P}_{s} + \frac{Δ i}{Δ e} ( {P}_{e} - {P}_{s} ) \qquad [ Equation 1 ]$$

where tₛ is time information of the start frame Fₛ, te is time information of the end frame Fₑ, tᵢ is time information of any frame Fᵢ, Pₛ is position information of the start frame Fₛ, Pₑ is position information of the end frame Fₑ, and Pᵢ′ is position information of any point Fᵢ′ on the regression line.

An algorithm for selecting any point Fᵢ′ on the regression line F̅ₛ̅F̅ₑ̅ having the same time information as any frame Fᵢ constituting a video may be expressed as Table 1 below:

TABLE 1
Algorithm 3: Regression(Fₛ, Fₑ, Fᵢ)

| | |
|---|---|
| 1 | F: an FOVstream |
| 2 | tₛ and Pₛ: timestamp and location of Fₛ |
| 3 | tₑ and Pₑ: timestamp and location of Fₑ |
| 4 | ti: timestamp of Fi |
| 5 | Δₑ = tₑ − tₛ |
| 6 | Δᵢ = tᵢ − tₛ |
| 7 | ${P}_{i}^{′} = {P}_{s} + \frac{Δi}{Δe} ( {P}_{e} - {P}_{s} )$ |
| 8 | return Pᵢ′ |

where F, FOVstream is a frame group including a plurality of frames, Fₛ is a start frame among the plurality of frames, tₛ is time information of the start frame, Pₛ is position information of the start frame, Fₑ is an end frame of the plurality of frames, tₑ is time information of the end frame, Pₑ is position information of the end frame, Fᵢ is any frame of the plurality of frames, and tᵢ is time information of any frame. Lines 5 to 8 of the algorithm shown in Table 1 indicate Equation 1 above.

After selecting any point Fᵢ′ on the regression line F̅ₛ̅F̅ₑ̅, the block generation apparatus may calculate a distance between any point Fᵢ′ on the regression line F̅ₛ̅F̅ₑ̅ and any frame Fᵢ (S130). In this case, the block generation apparatus may calculate the distance between any point Fᵢ′ on the regression line F̅ₛ̅F̅ₑ̅ and any frame Fᵢ based on the position information Pᵢ′ of any point Fᵢ′ on the regression line F̅ₛ̅F̅ₑ̅ and the position information Pᵢ of any frame Fᵢ, which are calculated through Equation 1.

After calculating the distance between any point Fᵢ′ on the regression line F̅ₛ̅F̅ₑ̅ and any frame Fᵢ, the block generation apparatus may determine any frame Fᵢ as a reference frame when the calculated distance is greater than a predefined reference distance (S140). On the other hand, when the calculated distance is equal to or less than the predefined reference distance, all operations may be completed or operations S120 and S130 may be performed again.

An algorithm for detecting a reference frame in which position information changes nonlinearly based on the position information of the video frames may be represented as Table 2 below:

TABLE 2
Algorithm 2: MarkupFOVScene_P(F, s, e, εp)

```
  1 F : an FOVstream
  2 s : starting index of F
  3 e : ending index of F
  4 εp : threshold
  5 for i ← s to e do
  6  Pᵢ′ = Regression (Fₛ, Fₑ, Fᵢ)
  7  dist = distance(Pᵢ′, Pᵢ)
  8  if dist > dist_max then
  9  dist_max ← dist
10  peak ← i
11  end
12 end
13 if dist_max > εp then
14  list1 = MarkupFOVScene_P(F, s, peak, εp)
15  list2 = MarkupFOVScene_P(F, s, peak, εp)
16  return list1 + List2
17 else
18  return [Fₛ, Fₑ]
19 end
```

where F, FOVstream is a frame group including a plurality of frames, s is an index of a start frame among the plurality of frames, e is an index of an end frame of the plurality of frames, ^{ε}P is a predefined reference distance, and MarkupFOVScene is a reference frame.

Lines 6 and 7 of the algorithm that is shown in Table 2 indicate that the distance between each Fᵢ′ on the regression line F̅ₛ̅F̅ₑ̅ and each frame Fᵢ is calculated based on the position information Pᵢ′ of the point Fᵢ′ on the regression line F̅ₛ̅F̅ₑ̅ and the position information Pᵢ of the frame Fᵢ.

Lines 8 to 10 of the algorithm that is shown in FIG. 2 indicate that a largest distance is selected from among the distances between any frame Fᵢ and any point Fᵢ′ on the regression line F̅ₛ̅F̅ₑ̅.

Lines 13 to 19 of the algorithm that is shown in FIG. 2 indicate that any frame Fᵢ is determined as the reference frame when the calculated distance is greater than the predefined reference distance ^{ε}P.

Process of Detecting Reference Frame Based on Direction Information of Frame

The block generation apparatus may calculate a median value of direction information based on direction information of the video frames (S210). The block generation apparatus may calculate a median value based on frames positioned in a certain time range. In this case, an average of minimum direction information (that is, direction information in which an angle with respect to a certain axis (for example, an X axis) is minimum) and maximum direction information (that is, direction information in which an angle with respect to a certain axis (for example, an X axis) is maximum) among direction information of the frames positioned in the certain time range may be calculated as the median value.

After calculating the median value, the block generation apparatus may determine any frame as the reference frame when a difference between the median value and the direction information of any frame among the video frames is greater than a predefined reference value (S220). On the other hand, when the difference between the median value and the direction information of any frame is equal to or less than the predefined reference value, all operations may be completed or operation S220 may be performed based on another frame.

An algorithm for detecting a reference frame in which direction information changes nonlinearly based on the direction information of the video frames may be represented as Table 3 below:

TABLE 3
Algorithm 4: MarkupFPVScene_d(F, s, e, ε_{\vec{d}})

```
  1 F: an FOVstream
  2 s : starting index of F
  3 e : ending index of F
  4 ε_{\vec{d}} : threshold
  5 for i ← s to e do
  6  // Get the mean \vec{d} of two extremes in the interval
  7  \vec{d}ᵢ′ = MiddleValue(F, s, i)
  8  dist = distance(\vec{d}ᵢ′, \vec{d}ᵢ)
  9  if dist > ε_{\vec{d}} then
10  list1 = [Fₛ, Fᵢ]
11  list2 = MarkupFOVScene_d(F, i, e, ε_{\vec{d}})
12  return list1 + list2
13  end
14 end
15 return [Fₛ, Fₑ]
```

where F, FOVstream is a frame group including a plurality of frames, s is an index of a start frame among the plurality of frames, e is an index of an end frame of the plurality of frames, ^{ε}\vec{d} is a predefined reference value, \vec{d}′ᵢ and is a median value.

Lines 5 to 7 of the algorithm that is shown in Table 3 indicate that the median value is calculated, and Lines 8 to 15 of the algorithm that is shown in Table 3 indicate that any frame is determined as the reference frame among the frames according to a difference between the median value and the direction information of the frame.

The block generation apparatus may generate a tilt block using the reference frame that is detected through operation S100, generate the tilt block using the reference frame that is detected through operation S200, generate the tilt block using a common reference frame among the reference frame detected through operation S100 and the reference frame detected through operation S200, and generate the tilt block using both of the reference frame detected through operation S100 and the reference frame detected through operation S200 as expressed as Table 4 below:

TABLE 4
Algorithm 1: FindingMarkupFOVScene(F, εp, ε_{\vec{d}})

1 F : an FOVstream
2 εp, ε_{\vec{d}} : threshold for errors of P and \vec{d}
3 S₁ = MarkupFOVScene_P(F, s, e, εₚ)
4 S₂ = MarkupFOVScene_d(F, s, e, ε_{\vec{d}})
5 return S₁ ∪ S₂

where F, FOVstream is a frame group including a plurality of frames, ^{ε}P is a predefined reference distance, ^{ε}\vec{d} is a predefined reference value, S₁ is a group of reference frames that are detected through operation S100, and S2 is a group of reference frames that are detected through operation S200.

Process of Generating Tilt Block Based on Reference Frame

After detecting a reference frame, the block generation apparatus may generate a tilt block including a plurality of frames based on the detected reference frame (S200).

First, the block generation apparatus may classify video frames into at least two groups based on the reference frame (S210). For example, in FIG. 5, when Fᵢ is determined as the reference frame, a start frame Fₛ, a reference frame Fᵢ, and frames between the start frame Fₛ and the reference frame Fᵢ may be classified into one group, and a reference frame Fᵢ, an end frame Fₑ, and frames between the reference frame Fᵢ and the end frame Fₑ may be classified into another group.

After classifying the frames into at least two groups based on the reference frame, the block generation apparatus may generate a tilt block that includes frames constituting the groups and is parallel with a line formed by a start frame and an end frame among the frames constituting the group (S220).

In FIG. 5, since a start frame of one group is Fₛ and an end frame is Fᵢ, the block generation apparatus may generate a tilt block that includes frames between Fₛ and Fᵢ and is parallel with a line formed by Fₛ and Fᵢ. Since a start frame of another group is Fᵢ and an end frame is Fₑ, the block generation apparatus may generate a tilt block that includes frames between Fᵢ and Fₑ and is parallel with a line formed by Fᵢ and Fₑ. That is, the block generation apparatus may generate a tilt block based on adjacent frames among a start frame, an end frame, and a reference frame.

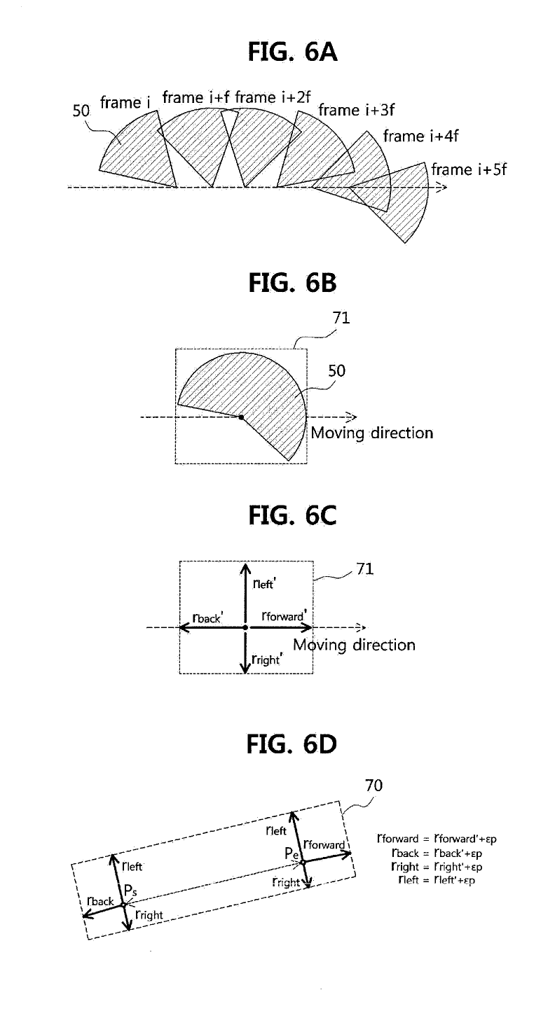

FIG. 6 is a conceptual view showing a process of generating a tilt block.

Referring to FIG. 6, a tilt block 70 generated according to an embodiment of the present invention will be described in detail. FIG. 6A shows frames 50 having the same position information (that is, latitude information) and different direction information. FIG. 6B shows a frame 50 obtained by positioning the frames 50 shown in FIG. 6A at one position. FIG. 6C shows a unit block 71 including one frame 50. FIG. 6D shows a tilt block 70 including a plurality of frames 50.

An angle of the frame 50 shown in FIG. 6B cannot be greater than θ (viewing angle information of the one frame 50 shown in FIG. 6A)+2×^{ε}\vec{d} (predefined reference value (that is, direction information error)). This is because ^{ε}\vec{d} is an error threshold value for direction information \vec{d} of the frame 50 included in the tilt block 70 shown in FIG. 6D.

The unit block 71 for the one frame 50 may be provided as shown in FIG. 6C. By expanding the unit block 71, the tilt block 70 including the plurality of frames 50 may be provided. In FIG. 6C, each of r_{left}′, r_{right}′, r_{forward}′, and r_{back}′ denotes a distance from a position (that is, a position according to position information) of the frame 50 included in the unit block 71 to a boundary of the unit block 71.

In FIG. 6D, the tilt block 70 is generated in parallel with a line formed by a start frame and an end frame. Here, all unit blocks 71 included in the tilt block 70 have the same size (that is, the same r_{left}′, r_{right}′, r_{forward}′, and r_{back}′) and position information that changes linearly. Here, an index of the tilt block 70 may be formed based on parameters (for example, r_{left}′, r_{right}′, r_{forward}′, and r_{back}′, position information, and direction information of the unit block 71) of one unit block 71 included in the tilt block 70.

The index of the tilt block may be represented as Table 5 below:

TABLE 5

| | |
|---|---|
| Pₛ | Starting point of location trajectory. |
| Pₑ | Ending point of location trajectory. |
| r_{left} | Maximum distance to left sides of moving direction |
| r_{right} | Maximum distance to right sides of moving direction |
| r_{forward} | Maximum distance to forward of moving direction |
| r_{back} | Maximum distance to backward of moving direction |

where Pₛ is position information of a start frame of a tilt block, Pₑ is position information of an end frame of the tilt block, and each of r_{left}, r_{right}, r_{forward}, and r_{back} is a distance from a position of the start frame to a boundary of the tilt block.

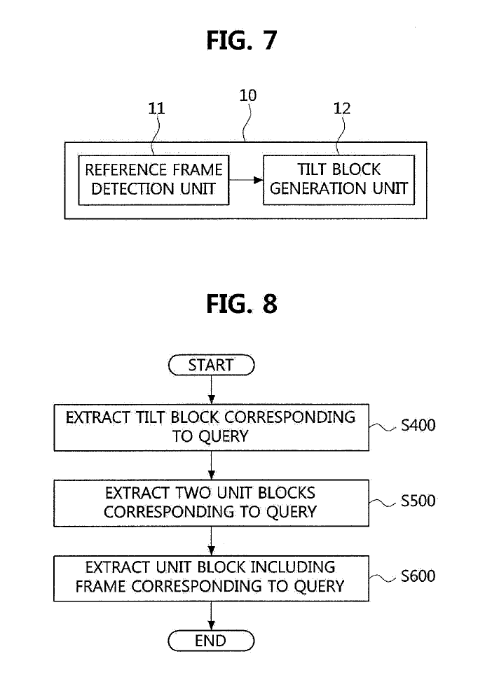

FIG. 7 is a block diagram showing a block generation apparatus for video retrieval according to an embodiment of the present invention.

Referring to FIG. 7, the block generation apparatus 10 may include a reference frame detection unit 11 and a tilt block generation unit 12.

The reference frame detection unit 11 may detect a reference frame in which at least one of the position information and the direction information, which are space information of the frame, changes nonlinearly among video frames.

Specifically, the reference frame detection unit 11 may generate a regression line based on a start frame and an end frame among video frames, select any point on the regression line having the same time information as any video frame, calculate a distance between the any point on the regression line and the any frame, and determine the any frame as the reference frame when the calculated distance is greater than a predefined reference distance. Here, a detailed method of the reference frame detection unit 11 determining the reference frame is the same as described in operation S100.

In addition, the reference frame detection unit 11 may calculate a median value of direction information based on direction information of video frames and determine any frame as the reference frame when a difference between direction information of the any frame among the video frames and the median value is greater than a predefined reference value. Here, a detailed method of the reference frame detection unit 11 determining the reference frame is the same as described in operation S200.

The tilt block generation unit 12 may generate a tilt block including a plurality of frames based on the reference frame that is detected by the reference frame detection unit 11. Specifically, the tilt block generation unit 12 may classify the video frames into at least two groups based on the reference frame and generate a tilt block that includes frames constituting a group and is parallel with a line that is formed by a start frame and an end frame among the frames constituting the group. Here, a detailed method of the tilt block generation unit 12 generating the tilt block is the same as described in operation S300.

Functions performed by the reference frame detection unit 11 and the tilt block generation unit 12 may be also performed by any processor (for example, a central processing unit (CPU), a graphic processing unit (GPU), etc.). The operations shown in FIGS. 3 and 4 may be performed by the any processor.

In addition, the reference frame detection unit 11 and the tilt block generation unit 12 may be implemented as one single form, one physical device, or one module. Moreover, the reference frame detection unit 11 and the tilt block generation unit 12 may be implemented as a plurality of physical devices or groups instead of one physical device or group.

FIG. 8 is a flowchart showing a method of processing a query according to an embodiment of the present invention.

Referring to FIG. 8, a query processing device may extract a tilt block corresponding to a query from among video tilt blocks (S400). Here, the query is a request to provide a frame having specific position information and may include position information of a desired frame.

Since one video has one or more tilt blocks, the query processing device may extract a tilt block corresponding to a query from among the tilt blocks of the video. In this case, since the position information of the tilt block may be found through an index shown in Table 5 above, the query processing device may extract the tilt block corresponding to the query based on the index. Here, since the tilt block is generated through the above-described block generation method for video retrieval, the tilt block is generated in parallel with a line formed by a start frame and an end frame that constitute the tilt block.

After extracting the tilt block corresponding to the query, the query processing apparatus may extract two unit blocks corresponding to the query based on a distance between the query and the start frame constituting the extracted tilt block from among unit blocks including frames constituting the extracted tilt block (S500).

After extracting the two unit blocks, the query processing apparatus may extract a unit block including a frame corresponding to a query based on position information of frames included in any unit block from among the extracted two unit blocks and unit blocks positioned between the two unit blocks (S600).

In this case, the query processing apparatus may extract a tilt block corresponding to the query by applying methods different depending on a type of the query (for example, a point query, a range query, etc.), extract two unit blocks corresponding to the query from among unit blocks including frames constituting the extracted tilt block, and extract a unit block including a frame corresponding to the query.

Method of Extracting Frame According to Point Query

Since the point query corresponds to the tilt block extracted in operation S400 and the tilt block includes a plurality of frames, it is inefficient to scan all frames included in the tilt block in order to extract a frame corresponding to the point query. In order to solve this problem, a query processing method according to an embodiment of the present invention includes scanning some frames included in the tilt block to extract the frame corresponding to the point query.

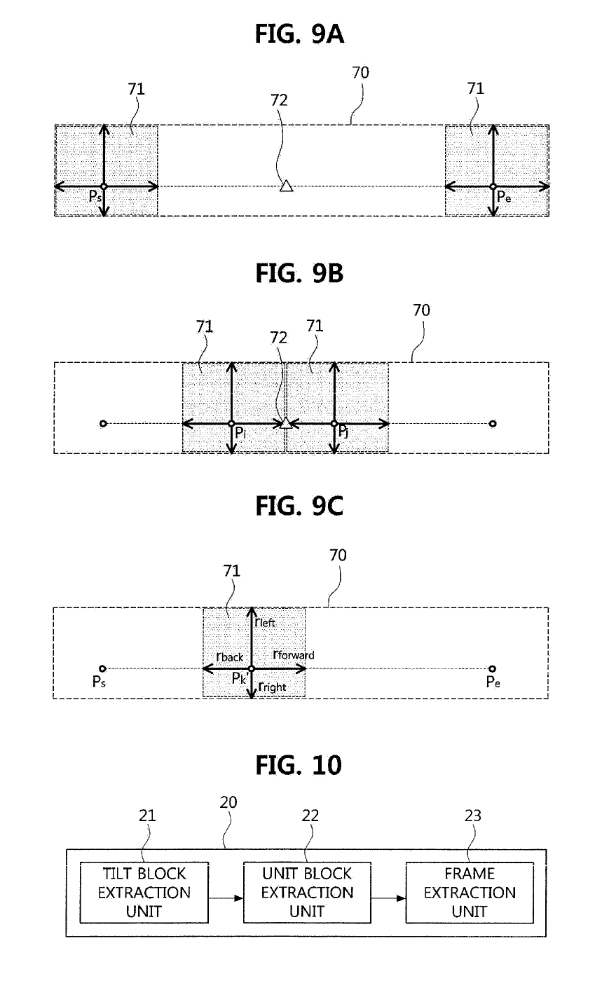

FIG. 9 is a conceptual view showing a process of extracting a frame corresponding to a query.

Referring to FIG. 9, a block represented using a dotted line is a tilt block 70, a block represented in grey is a unit block 71, and a triangle is a point query 80. Here, the tilt block 70 may include a plurality of unit blocks 71.

In FIG. 9A, the point query 80 is positioned in the tilt block 70, but the point query 80 does not correspond to the unit block 71 including the start block and the unit block 71 including the end frame. In FIG. 9B, a unit block 71 including a frame having position information Pᵢ and a unit block 71 including a frame having position information Pⱼ may correspond to the point query 80.

The tilt block 70 may represent a group in which the unit blocks 71 are cascaded, and there may be a plurality of unit blocks 71 corresponding to the point query 80. Among the plurality of unit blocks 71 corresponding to the point query 80, a first frame and a last frame on a time axis may be calculated through Equations 2 and 3 below (S500):

$$\begin{matrix}i = ⌈ ( D - {r}_{forward} ) \times \frac{n - 1}{l} ⌉ & [ Equation 2 ] \\ j = ⌈ ( D + {r}_{back} ) \times \frac{n - 1}{l} ⌉ & [ Equation 3 ]\end{matrix}$$

where i and j are numbers of frames included in the tilt block 70, and the frame numbers are marked sequentially from a start frame. For example, when the tilt block 70 includes 10 frames, a frame number of the start frame is 1 and a frame number of the end frame is 10. In addition, n is the total number of frames included in the tilt block 70, l is a length of a line formed by the start frame and the end frame of the tilt block 70, D is a distance from the start frame of the tilt block 70 to a point query 80 that is projected on the line formed by the start frame and the end frame of the tilt block 70, and r_{forward} and r_{back} are indices of the tilt block that are described in Table 5 above.

Since there is a frame corresponding to the point query 80 between an i-th frame calculated through Equation 2 and a j-th frame calculated through Equation 3, it is possible to extract a frame corresponding to the point query 80 by scanning a frame positioned between the i-th frame and the j-th frame instead of scanning all the frames included in the tilt block 70.

In FIG. 9C, when a k-th frame in the tilt block 70 corresponds to the point query 80, position information of the k-th frame may be represented as Pₖ′, Pₖ′ may be positioned on a line formed by the start frame and the end frame, and Pₖ′ may move along the line formed by the start frame and the end frame. Distances from Pₖ′ to boundaries of the unit block 71 including the k-th frame may be represented as r_{left}, r_{right}, r_{forward}, and r_{back}. Here, since the point query 80 is positioned within r_{left} or r_{right} from the line formed by the start frame and the end frame, r_{forward} and r_{back} may be considered to extract a frame corresponding to the point query 80.

When the point query 80 corresponds to the k-th frame, the point query 80 may be positioned forward within r_{forward} and rearward within r_{back} from Pₖ′ of the unit block 71 including the k-th frame.

Equation 4 below may be defined based on the above description, and it can be seen that the k-th frame satisfying Equation 4 corresponds to the point query 80:

$$k \times \frac{l}{n - 1} - {r}_{back} \leq D \leq k \times \frac{l}{n - 1} - {r}_{forward} \qquad [ Equation 4 ]$$

where n is a total number of frames included in the tilt block, l is a length of a line formed by the start frame and the end frame of the tilt block, D is a distance from the start frame of the tilt block to a point query that is projected on the line formed by the start frame and the end frame of the tilt block, and r_{forward} and r_{back} are indices of the tilt block that are described in Table 5 above.

In addition,

$$k \times \frac{l}{n - 1}$$

indicates a distance from the start frame of the tilt block to the k-th frame.

That is, the query processing apparatus may extract the frame corresponding to the point query using Equation 4 (S600).

An algorithm for extracting the frame corresponding to the point query is as expressed in Table 6 below:

TABLE 6
Algorithm 5: PointQueryInMBTR(q, MBTR)

| | |
|---|---|
| 1 | Pₛ: Starting point of location trajectory |
| 2 | Pₑ: Ending point of location trajectory |
| 3 | q: Query Point |
| 4 | n: Number of FOVs in MBTR. |
| 5 | L: List of matching FOVs. |
| 6 | l: Distance between Pₛ, Pₑ |
| 7 | r_{left}, r_{right}, r_{forward}, r_{back}: MBTR parameters |
| 8 | B: Boundary for MBTR |
| 9 | {B is tilted rectangle given four r values} |
| 10 | if pointPolygonIntersect(q, B) then |
| 11 | D = projectedDistance(Pₛ, Pₑ, q) |
| 12 | $i = ⌈ ( D - {r}_{forward} ) \times \frac{n - 1}{l} ⌉$ |
| 13 | $j = ⌊ ( D - {r}_{back} ) \times \frac{n - 1}{l} ⌋$ |
| 14 | for k ← i to j do |
| 15 | if pointFOVIntersect(q, Fₖ) then |
| 16 | addList(L, Fₖ) |
| 17 | end |
| 18 | end |
| 19 | end |
| 20 | return L |

where Pₛ is position information of the start frame, Pₑ is position information of the end frame, q is the point query, n is the number of frames included in the tilt block, L is a list of frame corresponding to the point query, l is a distance between the position information of the start frame and the position information of the end frame, r_{left}, r_{right}, r_{forward}, and r_{ack} are indices of the tilt block, and B is a boundary of the tilt block.

Lines 8 to 20 of the algorithm shown in Table 6 indicate that the unit block including the frame corresponding to the point query that is described with reference to Equations 2, 3, and 4 is extracted.

Method of Extracting Frame According to Range Query

The range query is a request to provide a frame having specific position information and may include a plurality of pieces of position information of a desired frame. The range query has the plurality of pieces of position information and thus may be represented as a convex polygon.

The query processing apparatus may extract a critical point at which the tilt block and the range query overlap each other. The critical point is defined as a crossing point of the boundary of the tilt block and an edge of the range query, an apex of the range query positioned inside the tilt block, and an apex of the tilt block positioned inside the range query.

The query processing apparatus may extract a tilt block having the critical point as the tilt block corresponding to the range query from among tilt blocks (S400).

After extracting the tilt block corresponding to the range query, the query processing apparatus may calculate a unit block including a first frame on a time axis among a plurality of unit blocks corresponding to the range query through Equation 5 below and may calculate a unit block including a last frame on the time axis among the plurality of unit blocks corresponding to the range query through Equation 6 below (S500):

$$\begin{matrix}i = ⌈ ( {D}_{min} - {r}_{forward} ) \times \frac{n - 1}{l} ⌉ & [ Equation 5 ] \\ j = ⌈ ( {D}_{max} + {r}_{back} ) \times \frac{n - 1}{l} ⌉ & [ Equation 6 ]\end{matrix}$$

where i and j are numbers of frames included in the tilt block, and the frame numbers are marked sequentially from a start frame. For example, when the tilt block includes 10 frames, a frame number of the start frame is 1 and a frame number of the end frame is 10. n is a total number of frames included in the tilt block, l is a length of a line formed by the start frame and the end frame of the tilt block, Dₘᵢₙ is a length between the start frame and a critical point that is present at a position closest to the start frame among critical points, Dₘₐₓ is a length between the start frame and a critical point that is present at a position farthest from the start frame among the critical points, and r_{forward} and r_{back} are indices of the tilt block that are described in Table 5 above.

That is, a unit block including an i-th frame calculated through Equation 5 is a unit block corresponding to a critical point that is present closest to the start frame, and a unit block including a j-th frame calculated through Equation 6 is a unit block corresponding to a critical point that is present farthest from the start frame.

Since there is a frame corresponding to the range query between the i-th frame calculated through Equation 5 and the j-th frame calculated through Equation 6, it is possible to extract a frame corresponding to the range query by scanning a frame positioned between the i-th frame and the j-th frame instead of scanning all the frames included in the tilt block.

After extracting two unit blocks corresponding to the range query, the query processing apparatus may extract the frame corresponding to the range query using Equation 4 above.

An algorithm for extracting the frame corresponding to the range query is as expressed in Table 7 below:

TABLE 7
Algorithm 6: RangeQueryInMBTR(q, MBTR)

| | |
|---|---|
| 1 | Pₛ: Starting point of location trajectory |
| 2 | Pₑ: Ending point of location trajectory |
| 3 | Q: Query Range {Q is given by convex polygon} |
| 4 | n: Number of FOVs in MBTR. |
| 5 | L: List of matching FOVs. |
| 6 | l: Distance between Pₛ, Pₑ |
| 7 | B: Boundary for MBTR |
| 8 | {B is tilted rectangle given four r values} |
| 9 | C: Set of critical points to check |
| 10 | /* Collecting critical point */ |
| 11 | C = getIntersections(B, Q) |
| 12 | for ∀v_{Q} ∈ Q do |
| 13 | if pointPolygonIntersect(v_{Q}, B) then |
| 14 | C = C ∪ v_{Q} |
| 15 | end |
| 16 | end |
| 17 | for ∀v_{B} ∈ B do |
| 18 | if pointPolygonIntersect(v_{B}, Q) then |
| 19 | C = C ∪ v_{B} |
| 20 | end |
| 21 | end |
| 22 | /* MBTR lookup */ |
| 23 | if C ≠ φ then |
| 24 | Dₘᵢₙ = min_{v∈C}projectedDistance(Pₛ, Pₑ, v) |
| 25 | Dₘₐₓ = max_{v∈C}projectedDistance(Pₛ, Pₑ, v) |
| 26 | $i = ⌈ ( {D}_{min} - {r}_{forward} ) \times \frac{n - 1}{l} ⌉$ |

where Pₛ is position information of the start frame, Pₑ is position information of the end frame, Q is the range query, n is the number of frames included in the tilt block, L is a list of frame corresponding to the range query, l is a distance between the position information of the start frame and the position information of the end frame, and B is a boundary of the tilt block.

Lines 8 to 34 of the algorithm shown in Table 7 indicate that the unit block including the frame corresponding to the range query that is described with reference to Equations 4, 5, and 6 is extracted.

FIG. 10 is a block diagram showing a query processing apparatus according to an embodiment of the present invention.

Referring to FIG. 10, the query processing apparatus 20 may include a tilt block extraction unit 21, a unit block extraction unit 22, and a frame extraction unit 23. Here, the tilt block is formed in parallel with a line formed by the start frame and the end frame constituting the tilt block.

The tilt block extraction unit 21 may extract a tilt block corresponding to the query from among tilt blocks including a plurality of frames constituting a video. Here, a detailed method of the tilt block extraction unit 21 extracting a tilt block corresponding to the query is the same as described in operation S400.

The unit block extraction unit 22 may extract two unit blocks corresponding to the query based on a distance between the query and the start frame constituting the extracted tilt block from among unit blocks including frames constituting the extracted tilt block. Here, a detailed method of the unit block extraction unit 22 extracting a unit block corresponding to the query is the same as described in operation S500.

The frame extraction unit 23 may extract a unit block including a frame corresponding to a query based on position information of frames included in any unit block from among the extracted two unit blocks and unit blocks positioned between the two unit blocks. Here, a detailed method of the frame extraction unit 23 extracting a unit block including the frame corresponding to the query is the same as described in operation S600.

Functions performed by the tilt block extraction unit 21, the unit block extraction unit 22, and the frame extraction unit 23 may be also performed by any processor (for example, a central processing unit (CPU), a graphic processing unit (GPU), etc.). The operations shown in FIG. 8 may be performed by the any processor.

In addition, the tilt block extraction unit 21, the unit block extraction unit 22, and the frame extraction unit 23 may be implemented as one single form, one physical device, or one module. Moreover, the tilt block extraction unit 21, the unit block extraction unit 22, and the frame extraction unit 23 may be implemented as a plurality of physical devices or groups instead of one physical device or group.

Table 8 below represents the subroutines shown in Tables 1, 2, 3, 4, 6, and 7.

TABLE 8

| | |
|---|---|
| pointP olygonIntersect(q, P) | Returns true if point q overlaps with |
| | polygon P |
| pointFOV Intersect(q, F) | Returns true if point q overlaps with |
| | FOVScene F |
| polygonFOV Intersect(P, F) | Returns true if polygon P overlaps with |
| | FOVScene F |
| getIntersections(P₁, P₂) | Returns all intersection points between |
| | polygon P1 and P2 |
| addList(L, Fₖ) | Add frame id of F into L |
| projectedDistance(Pₛ, Pₑ, q) | Distance of q from Pₛ, where q is projection of q onto \vec{PₛPₑ}. $It is given by \frac{\vec{{P}_{s} q} \cdot \vec{{P}_{s} {P}_{e}}}{\vert \vec{{P}_{s} {P}_{e}} \vert}$ |

Here, pointPolygonItersect(q, P) indicates “true” when a point query q and a polygon P (for example, a tilt block, a unit block, etc.) overlap each other, pointFOVIntersect(q, F) indicates “true” when the point query q and a frame F overlap each other, polygonFOVIntersect(P, F) indicates “true” when the polygon P (for example, a tilt block, a unit block, etc.) and the frame F overlap each other, getIntersections(P₁, P₂) indicates all crossing points between the polygon P₁ (for example, a tilt block, a unit block, etc.) and the polygon P₂ (for example, a range query, etc.), addList(L, Fₖ) indicates that the frame is added to a list of the frame corresponding to the query, and projectedDistance(Pₛ, Pₑ, q) indicates a distance between the start frame and the query q projected on the line formed by the start frame and the end frame.

Result of Experiment

Table 9 below is a result of comparing a query processing time and a memory usage according to the query processing method of an embodiment of the present invention with a query processing time and a memory usage according to the conventional query processing method.

TABLE 9

| | MBR-Filtering | R-Tree | GeoTree |
|---|---|---|---|
| Range | 297,800 | 6,039.4 | 4,554.2 |
| Query(ms) | (4400) | (374.4) | (153.6) |
| Point | 68,297 | 1,302.0 | 1,264.5 |
| Query(ms) | (492.3) | (17.28) | (67.75) |
| Memory | 16.6 | 27.3 | 2.83 |
| Use(MB) | | | |

Here, GeoTree is the query processing method according to an embodiment of the present invention, and each of MBR-Filtering and R-Tree is the conventional query processing method.

With respect to the range query, 10,000 queries were generated at random to conduct the experiment. As a result, it can be seen that GeoTree, which is the query processing method according to an embodiment of the present invention, has processed the range query most quickly. Here, a numerical value in a parenthesis is a standard deviation.

With respect to the point query, 100,000 queries were generated at random to conduct the experiment. As a result, it can be seen that GeoTree, which is the query processing method according to an embodiment of the present invention, has processed the point query most quickly. Here, a numerical value in a parenthesis is a standard deviation.

With respect to the memory usage, it can be seen that GeoTree, which is the query processing method according to an embodiment of the present invention, using a smallest amount of memory.

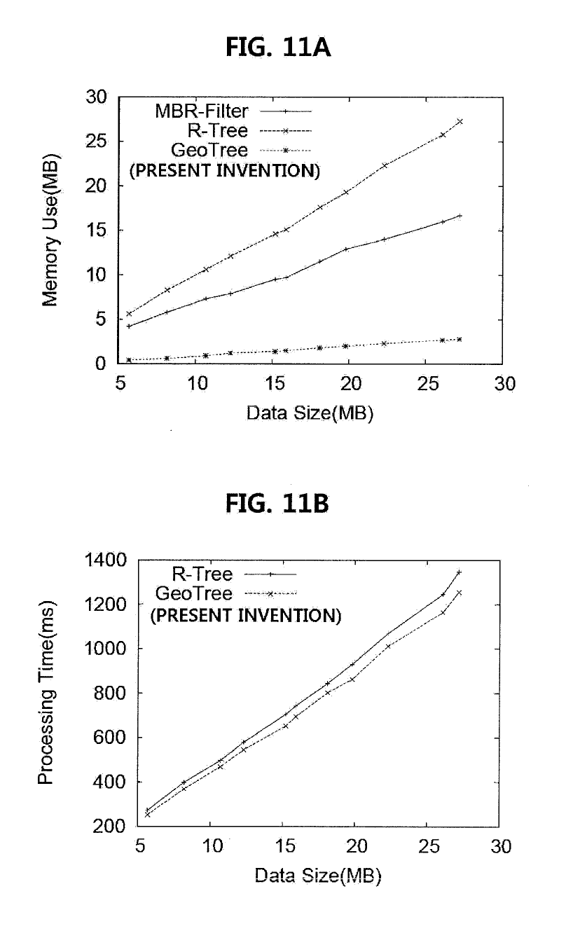

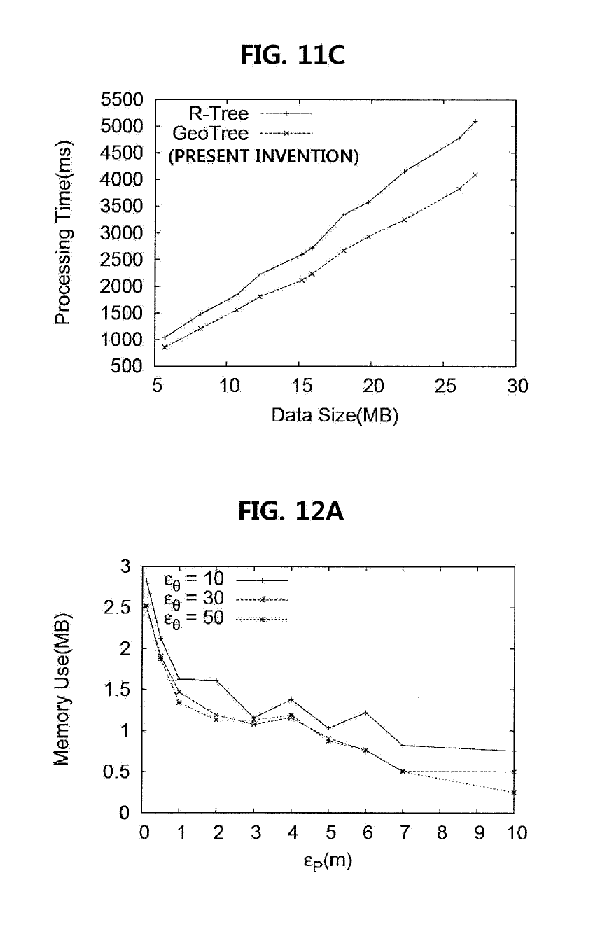

FIG. 11 is a graph showing performance of the query processing method according to a size of data.

FIG. 11A is a graph that compares memory usage according to the size of the data, in which an X axis indicates the size of the data and a Y axis indicates the memory usage. In FIG. 11A, it can be seen that the query processing method (GeoTree) according to an embodiment of the present invention uses a smaller amount of memory than the conventional query processing methods (MBR-Filter and R-Tree).

FIG. 11B is a graph that compares processing times of the point query, in which an X axis indicates the size of the data and a Y axis indicates the processing times. In FIG. 11B, it can be seen that the query processing method (GeoTree) according to an embodiment of the present invention has processed the point query more quickly than the conventional query processing method (R-Tree).

FIG. 11C is a graph that compares processing times of the range query, in which an X axis indicates the size of the data and a Y axis indicates the processing times. In FIG. 11C, it can be seen that the query processing method (GeoTree) according to an embodiment of the present invention has processed the range query more quickly than the conventional query processing method (R-Tree).

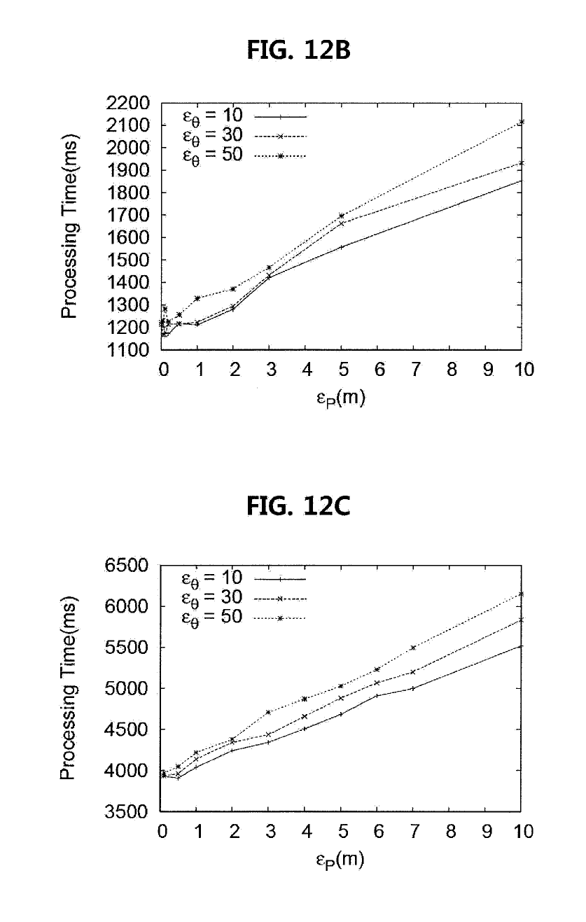

FIG. 12 is a graph showing performance of the query processing method according to change in a parameter.

Here, ^{ε}P is a predefined reference distance described in operation S140, and ^{ε}θ is a predefined reference value described in operation S220.

FIG. 12A is a graph showing the amount of memory used in the query processing method according to an embodiment of the present invention according to a change in parameters (the Y axis indicates memory usage). FIG. 12B is a graph showing a time of processing a point query in the query processing method according to an embodiment of the present invention according to a change in parameters (the Y axis indicates a processing time). FIG. 12C is a graph showing a time of processing a range query in the query processing method according to an embodiment of the present invention according to a change in parameters (the Y axis indicates a processing time).

It can be seen from FIG. 12 that the memory usage and the query processing time have a trade-off relationship.

According to an embodiment of the present invention, it is possible to process the same amount of query in a small amount of time using a small amount of memory, compared to conventional techniques, by generating a tilt block based on position information and direction information of a frame that change linearly and processing a query based on the tilt block.

While the example embodiments of the present invention and their advantages have been described in detail, it should be understood that various changes, substitutions, and alterations may be made herein without departing from the scope of the invention.

What is claimed is:

1. A method of generating a block for video retrieval, which is performed by an apparatus for generating the block for the video retrieval, the method comprising:
detecting a reference frame having at least one of position information and direction information that changes nonlinearly from among frames constituting a video, the position information and direction information being space information of the frame; and
generating a tilt block including a plurality of frames based on the reference frame.

2. The method of claim 1, wherein the detecting of the reference frame comprises:
generating a regression line based on a start frame and an end frame among the frames constituting the video;
selecting any point having the same time information as any frame constituting the video on the regression line;
calculating a distance between the any point on the regression line and the any frame; and
determining the any frame as the reference frame when the calculated distance is greater than a predefined reference distance.

3. The method of claim 1, wherein the detecting of the reference frame comprises:
calculating a median value of direction information based on direction information of the frames constituting the video; and
determining any frame as the reference frame among the frames constituting the video when a difference between the median value and direction information of the any frame is greater than a predefined reference value.

4. The method of claim 1, wherein the generating of the tilt block comprises:
classifying the frames constituting the video into at least two groups based on the reference frame; and
generating a tilt block including frames constituting a group in parallel with a line formed by a start frame and an end frame among the frames constituting the group.

5. An apparatus for generating a block for video retrieval, the apparatus comprising:
a detection unit configured to detect a reference frame having at least one of position information and direction information that changes nonlinearly from among frames constituting a video, the position information and direction information being space information of the frame; and
a generation unit configured to generate a tilt block including a plurality of frames based on the reference frame,
wherein the generation unit generates the tilt block in parallel with a line formed by a start frame and an end frame among the plurality of frames.

6. A method of processing a query by a query processing apparatus, the method comprising:
extracting a tilt block corresponding to the query from among tilt blocks including a plurality of frames constituting a video;
extracting two unit blocks corresponding to the query based on a distance between the query and a start frame constituting the extracted tilt block from among the unit blocks including the frames constituting the extracted tilt block; and
extracting a unit block including the frame corresponding to the query based on position information of a frame included in any unit block from among between the extracted two unit blocks and a unit block positioned between the two unit blocks,
wherein the tilt block is generated in parallel with a line formed by a start frame and an end frame constituting the tilt block.

7. The method of claim 6, wherein the extracting of the tilt block corresponding to the query comprises: when the query is a range query, detecting critical points at which the range query and the tilt blocks overlap each other and detecting a tilt block including the critical points from among the tilt blocks.

8. The method of claim 7, wherein the extracting of the two unit blocks comprises: extracting a first unit block corresponding to a critical point closest to the start frame and a second unit block corresponding to a critical point farthest from the start frame, from among the frames constituting the extracted tilt block.

9. The method of claim 8, wherein the extracting of the unit block including the frame corresponding to the query comprises extracting a unit block including a frame corresponding to the range query based on position information of a frame included in any unit block among the first unit block, the second unit block, and a unit block positioned between the first unit block and the second unit block.

10. A query processing apparatus comprising:
a first extraction unit configured to extract a tilt block corresponding to a query from among tilt blocks including a plurality of frames constituting a video;
a second extraction unit configured to extract two unit blocks corresponding to the query based on a distance between the query and a start frame constituting the extracted tilt block from among unit blocks including the frames constituting the extracted tilt block; and
a third extraction unit configured to extract a unit block including a frame corresponding to the query based on position information of a frame included in any unit block from among between the extracted two unit blocks and a unit block positioned between the two unit blocks,
wherein the tilt block is generated in parallel with a line formed by a start frame and an end frame constituting the tilt block.
